(19) United States
(12) Patent Application Publication
(10) Pub. No.: US 2010/0003477 A1
(43) Pub. Date: Jan. 7, 2010

(54) PUFFY STICKER

(76) Inventor: SHIH-FENG LEE, Taipei County (TW)

Correspondence Address: LEONG C LEI, PMB # 1008, 1867 YGNACIO VALLEY ROAD, WALNUT CREEK, CA, 94598, US

(21) Appl. No.: 12/167,255

(22) Filed: Jul. 3, 2008

(51) Int. Cl. B32B 5/00

(52) U.S. Cl. 428/211.1

(57) ABSTRACT

The puffy sticker contains a base layer, and one or more pattern layers made of a puffy material coated sequentially on pre-determined areas of a top side of the base layer in a layer-by-layer manner, where these pattern layers jointly present a colorful graphic image. The graphic image is then bulged by thermally curing these pattern layers. A cutting line is provided surrounding the graphic image so that the sticker having the puffy or foamy image can be detached. The base layer is made of paper, cloth, or similar material which adhesives coated on a bottom side of the base layer.

### TECHNICAL FIELD OF THE INVENTION

The present invention generally relates to stickers, and more particularly to a multi-layered puffy sticker capable of exhibiting a more vivid three-dimensional visual effect.

### DESCRIPTION OF THE PRIOR ART

A puffy sticker (or a foam sticker) is usually structured as illustrated in FIG. 1. The sticker is formed on a base layer 1 having adhesives coated on a bottom side. The base layer 1 is usually made of cloth, paper, or similar material. On a top side of the base layer 1, a pattern layer 1 showing a colorful graphic image is formed by coating a puffy or foamy material of various colors. The graphic image then becomes bulged by thermally curing the pattern layer 11. A cutting line 12 is provided surrounding the graphic image so that the sticker having the puffy or foamy image can be detached. As described, the puffy sticker has a single layer of puffy or foamy material and therefore the three-dimensional visual effect is often dull.

### SUMMARY OF THE INVENTION

Accordingly, a novel puffy sticker is provided herein that is capable of presenting a more appealing three-dimensional visual effect and a softer touching feeling.

The puffy sticker contains a base layer, and one or more pattern layers, each made of a puffy material, coated sequentially on predetermined areas of a top side of the base layer in a layer-by-layer manner, where these pattern layers jointly present a graphic image. The graphic image is then bulged by thermally curing these pattern layers. A cutting line is provided surrounding the graphic image so that the sticker having the puffy or foamy image can be detached.

The puffy materials for the pattern layers are of various colors, so that a colorful graphic image could be achieved.

The base layer is made of paper, cloth, or similar material where adhesives are coated on a bottom side of the base layer.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a structure of a conventional puffy sticker.

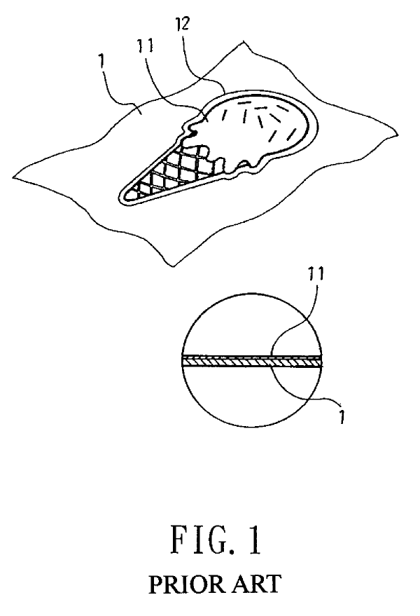

FIGS. 2 to 5 show the various steps of a process forming a puffy sticker according to the present invention.

FIG. 6 is a flow diagram showing the processing steps of FIGS. 2 to 5.

FIG. 7 shows a second application scenario of the present invention.

FIG. 8 shows a third application scenario of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

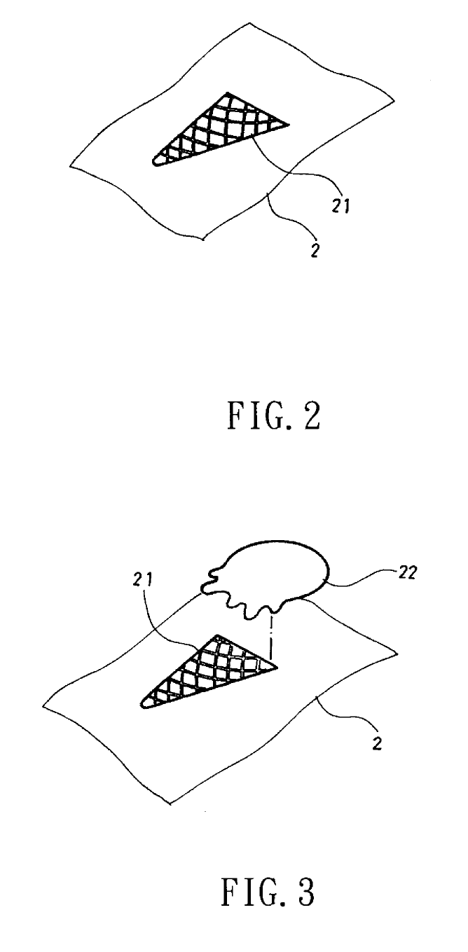

As shown in FIGS. 2 and 5, a puffy sticker according to an embodiment of the present invention is formed on a base layer 2 having adhesives coated on a bottom side. The base layer 2 is made of cloth, paper, or similar material. On a top side of the base layer 2, a first pattern layer 21 is formed by coating a puffy or foamy material. Then, a second pattern layer 22 and a third pattern layer 23 made of puffy materials are sequentially coated on the first pattern layer 21 in a layer-by-layer manner. Depending on the design of the sticker, additional pattern layers could be formed. These pattern layers jointly present a graphic image which becomes bulged by thermally curing these pattern layers. A cutting line 24 is provided surrounding the graphic image so that the sticker having the puffy or foamy image can be detached. As described, the puffy sticker has multiple layers of puffy or foamy materials and therefore the three-dimensional visual effect is more appealing, and a softer touching feeling is achieved.

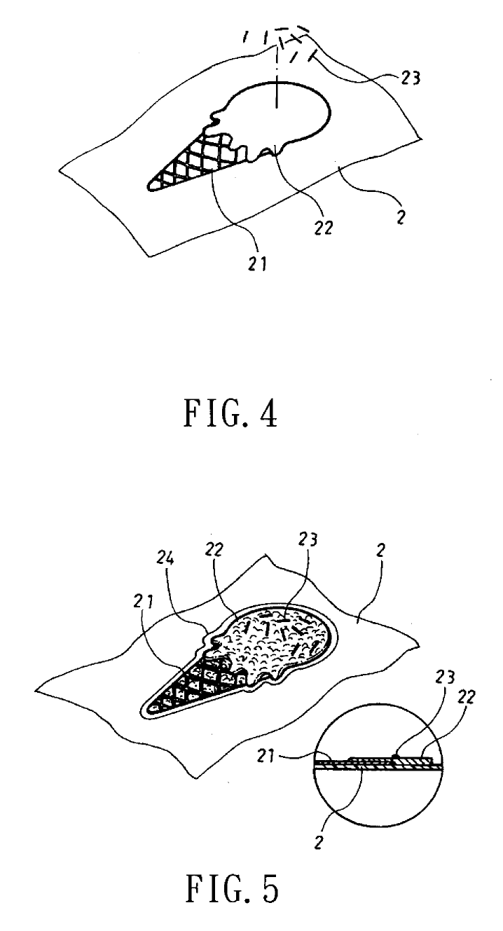

The process of forming the puffy sticker is also described in FIG. 6. Together with FIGS. 2 to 5, the first pattern layer 21 showing a graphic image of a cone is coated on the base layer 2.

Then, the second pattern layer 22 showing a graphic image of an ice cream is coated on top of a pre-determined area of the base layer 2, which overlapping a portion of the first pattern layer 21.

Then, the third pattern layer 23 showing a graphic image of icing is coated on top of another pre-determined area of the base layer 2, which is directly over of the second pattern layer 22. A complete graphic image of an ice cream cone with icing is shown on the base layer 2.

These pattern layers 21, 22, and 23 are then thermally cured to become bulged, showing a three-dimensional ice cream cone of varying levels of bulginess. A cutting line 24 is then provided surrounding the three-dimensional ice cream cone. Finally, the sticker is detached along the cutting line 24.

As mentioned earlier, there could be one or more pattern layers formed on top of the first pattern layer, according to the design of the final, complete graphic image.

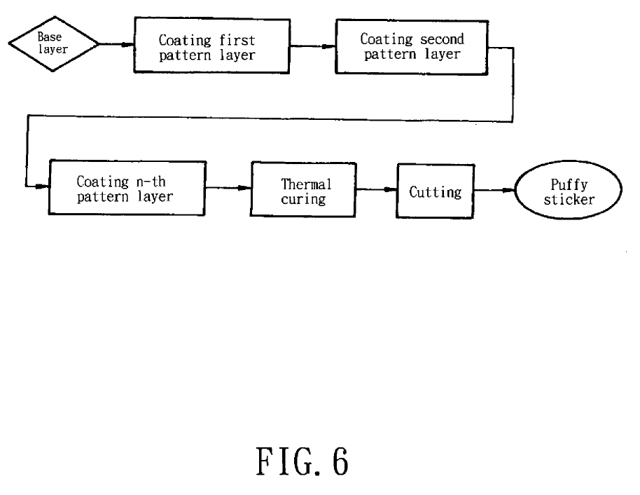

FIG. 7 shows a second application scenario of the present invention. As illustrated, a puffy sticker showing a bowl of crushed ice in a tray is formed by coating a first pattern layer 31 showing the tray, a second pattern layer 32 showing the bowl, a third pattern layer 33 showing the crushed ice, sequentially in the order on top of a base layer 3 having bottom adhesives. The sticker is then detached along a cutting line 34.

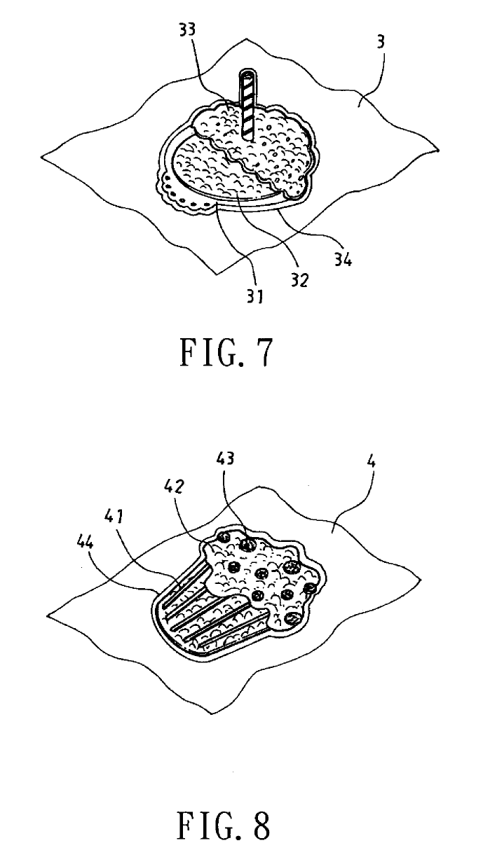

FIG. 8 shows a third application scenario of the present invention. As illustrated, a puffy sticker showing a cup cake is formed by coating a first pattern layer 41 showing the cup, a second pattern layer 42 showing the cake, a third pattern layer 43 showing the icing, sequentially in the order on top of a base layer 4 having bottom adhesives. The sticker is then detached along a cutting line 44.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illumed and in its operation can be made by those skilled in the art without departing in any way from the spirit of the present invention.

I claim:

1. A puffy sticker, comprising:
a base layer; and
one or more pattern layers made of a puffy material coated sequentially on pre-determined areas of a top side of said base layer in a layer-by-layer manner, where said pattern layers jointly present a colorful graphic image;
wherein said graphic image is bulged by thermally curing said patter layers; and said puffy sticker is detached by providing a cutting line surrounding said graphic image.

2. The puffy sticker according to claim 1, wherein said base layer is made of paper or cloth.

3. The puffy sticker according to claim 1, wherein said puffy materials of said pattern layers are of various colors.
